(19) United States
(12) Patent Application Publication
(10) Pub. No.: US 2009/0262907 A1
(43) Pub. Date: Oct. 22, 2009

(54) SYSTEM AND METHOD FOR AUTOMATED TELEPHONIC DEPOSITION RECORDING AND TRANSCRIPTION

(76) Inventor: BRETT D. ARQUETTE, Orlando, FL (US)

Correspondence Address: McKinney Law, LLC, 121 S. Orange Ave, Suite 1500, Orlando, FL, 32801, US

(21) Appl. No.: 12/347,101

(22) Filed: Dec. 31, 2008

Related U.S. Application Data
(60) Provisional application No. 61/124,778, filed on Apr. 21, 2008.

(51) Int. Cl. H04M 1/64; H04M 3/42; H04M 11/00

(52) U.S. Cl. 379/69; 379/207.13; 379/88.14

(57) ABSTRACT

A system and method for automated telephonic deposition recording and transcription is disclosed. In a particular embodiment, a connection is established between a telephone and a CPU. An audio record is opened, wherein the audio record is associated with a user number. A deposition is recorded to the audio record. In addition, responses to a plurality of prompts issued by the CPU are recorded to the audio record. Further, the audio record is transferred to a database, wherein voice tags are contemporaneously associated with each response recorded in response to a prompt. The audio record is then parsed into a plurality of audio files, wherein each audio file corresponds to a respective voice tag. Access is provided to the plurality of audio files, wherein text may be entered that is associated with a selected audio file. In addition, each audio file is correlated with text of a transcribed record when the audio record has been transcribed.

### I. CROSS REFERENCE TO RELATED APPLICATIONS

This application claims the benefit of U.S. Provisional Application No. 61/124,778 filed Apr. 21, 2008. The disclosure of the provisional application is incorporated herein by reference.

### II. FIELD

The present invention relates in general to the field of audio and video playback systems, and in particular to a method and system for automated telephonic deposition recording and transcription.

### III. DESCRIPTION OF RELATED ART

Depositions, interviews, hearings and conferences are typically conducted by gathering all parties in a room around a table so that each person can see and hear the proceedings and potentially participate in them. In a deposition, the deponent is asked questions orally and the deponent provides oral answers to the questions while a court reporter, or official reporter, takes a shorthand recording of the questions and answers using a shorthand machine. The machine shorthand recording is translated to a transcript text that may be provided to the parties several days following the deposition.

In the past, the court reporter has recorded the depositions in shorthand on a paper tape using the stenograph machine. The court reporter then converts the shorthand from the paper tape of the stenograph machine to the desired language in text form. The transcription process is expensive and time-consuming. Accordingly, there is a need in the relevant art for a system and method that is automated to expeditiously transcribe deposition testimony at a reduced cost.

There is also a need in the art for a system and method that has the ability to record deposition testimony when deponents and attorneys may contemporaneously be at both remote and local locations.

However, in view of the prior art at the time the present invention was made, it was not obvious to those of ordinary skill in the pertinent art how the identified needs could be fulfilled.

### IV. SUMMARY

One particular advantage provided by the embodiments of the system and method for automated telephonic deposition recording and transcription is that attorneys may perform and record a deposition from any phone to a voice center system, anywhere and at anytime, 24 hours a day, 365 days a week, (even from a cell phone). Thus, the need to have computers or access to the Internet during the recording process is eliminated. Consequently, attorneys may be required to travel less, which saves costs and the need to have a court reporter present during a deposition is eliminated. The entire recording process is completed by the voice center system using standard telephones so that no special software or equipment is required

Another particular advantage provided by the embodiments of the system and method for automated telephonic deposition recording and transcription is an auto-annotation process. In operation, an organization may upload a schedule of upcoming depositions into a database using a graphical user interface. A user may then enter a subpoena number using a telephone keypad before beginning each deposition on the schedule. Text is automatically associated with each deposition on the schedule when the deposition is completed and transmitted to the database. Thus, saving time and more efficiently processing audio files associated with a deposition.

In addition, the deposing attorney has the option of creating breaks in a deposition by using a note function of the system and method. At any point during the deposition, the deposing attorney may press the number “1” on the telephone keypad. A voice center system responds by announcing, “Creating Note Number 1.” The attorney may then make a manual note in his notebook and at that time may elect to change his line of questioning. In succession, the deposing attorney has the option of pressing “2”, “3”, “4” . . . , etc. The voice phone center may record any multiple of notes and create separate digital audio files for each note, which may be individually downloaded from the database after the deposition has concluded. A particular advantage provided by the note function is that the deposing attorney has the option of downloading a particular segment of the deposition from the database, or having a single segment of the deposition transcribed, since the attorney elected to break up the deposition dynamically while the deposition was being recorded.

Another particular advantage provided by the embodiments of the system and method for automated telephonic deposition recording and transcription is that the voice phone center provides for an attorney to perform a test of phone levels by recording a small piece of audio and then immediately having the voice phone center play it back. This feature allows the acoustics of the recording to be adjusted, for example, by moving people closer or further away from the phone depending on recorded voice levels. The voice phone center also provides safeguards from the conference phone being accidently muted or non-functional by notifying the attorney with a verbal warning if no audio sound has been detected during a particular period of time, e.g., 60 seconds. Accordingly, this prevents continuing with a deposition when it is not being recorded.

Another particular advantage provided by the embodiments of the system and method for automated telephonic deposition recording and transcription is that there is no need for an attorney to schedule a court reporter in advance of a deposition. The voice phone center is always available to accept connections and does not take vacations. Eliminating the need to schedule in advance in order to record a deposition further reduces the time involved, which future reduces the overall costs associated with court proceedings.

In addition, there is no need to have computers connected to the Internet in order to perform a deposition, which in turn eliminates technical problems associated with modern corporation-to-corporation Internet firewall restrictions, as well as bandwidth issues, Internet interruptions, and computer hardware and software issues that can cause anything from dropped audio, to catastrophic failure and data loss.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a flow diagram of a particular illustrative embodiment of a method for automated telephonic deposition recording and transcription;

FIG. 2 is a flow diagram of a particular illustrative embodiment of a method for accessing audio records of a deposition using a graphical user interface;

FIG. 3 is an illustrative diagram of a particular illustrative embodiment of a system for automated telephonic deposition recording and transcription;

FIG. 4 is an illustrative diagram of a particular illustrative embodiment of a system for automated telephonic deposition recording and transcription with a third party at a remote location;

FIG. 5 is a screen shot of a graphical user interface that may be used to search for audio records of a selected deposition;

FIG. 6 is a screen shot of a graphical user interface that may be used to display icons associated with audio files and fields to enter data associated with each selected audio file;

FIG. 7 is a screen shot of a graphical user interface that may be used to select a category from a drop down menu to search a database for audio records associated with that category;

FIG. 8 is a screen shot of a graphical user interface that may be used to select an organization from a drop down menu to search a database for audio records associated with that organization;

FIG. 9 is a screen shot of a graphical user interface displaying a digital certificate number associated with audio files of a deposition;

FIG. 10 is a screen shot of graphical user interface that may be used to order a transcript of a deposition;

FIG. 11 is a screen shot of a graphical user interface that may be used to manipulate audio files associated with a deposition;

FIG. 12 is a screen shot of a graphical user interface that may be used to electronically download a transcript of a deposition in accordance with an embodiment of the present invention;

FIG. 13 is a screen shot of a graphical user interface that may be used to play back audio files contemporaneously with viewing a transcript of a deposition associated with the audio files; and

FIG. 14 is a screen shot of the deposition details screen showing a method of playing the Main Note (main deposition) using the Windows Media Player, as well as showing the Digital Certification Number for that particular deposition.

### VI. DETAILED DESCRIPTION

The present invention permits participation in a deposition from local and remote locations, or any combination thereof, including live multi-party audio, which is digitally recorded via an analogue or digital phone line. Another aspect of the invention is the automated transference of audio files and metadata from a voice phone center via the Internet to a database. After the deposition has concluded, the deposing attorney (or whoever has been granted access to the deposition) can log into the database using a graphical user interface, search for the deposition and download the audio files, share the audio, or have it transcribed.

In operation, the deponent, the deposing attorney, and opposing attorney may meet in a room that has a standard conference phone including a microphone and speaker. The phone may be used by the deposing attorney to conference in any of the parties that would like to connect using a remote telephone from their office, car, another state, even another county. Once all parties are present or on the conference phone call, the deposing attorney calls a predetermined telephone number and is connected to the voice phone center. A central processing unit (“CPU”) at the voice phone center begins a prompting process by issuing audio prompts over the conference phone for information, such as, “please state your case information and press the pound key,” “please have the deponent state their name and press the pound key,” etc. The appropriate party responds orally to each prompt and the responses are recorded at the voice phone center. Once the prompt process has concluded, the parties are informed that the recording of the deposition will begin after an audio signal, such as a “beep.” After the audio signal, the main body of the deposition begins. Each respective oral response relating to the voice prompts and deposition may be stored as individual digital audio files at the voice phone center.

The database may be connected to the voice phone center CPU at regular intervals and the digital audio files are transferred to the database for storage and processing. A voice tag may be associated with each audio file and each audio file may be assigned and identified with a particular attorney. Accordingly, when a user logs into the database using a graphical user interface, a list of the depositions associated with the particular attorney may be displayed to the user.

The user can playback each of the voice tags and type text into the corresponding fields as he or she listens to what has been recorded in each voice tag. This process may be called the annotation process, which is a general term used in the court reporting industry, but has special meaning in this method and system disclosed herein. The voice tags may consist of “Case Number”, “Case Style”, “Deponent Name”, “Deposing Attorney”, “Opposing Attorney”, “Other People in Attendance”, “Deponent Swear In”, “Subpoena Number” and “Objections.” The voice tags may be annotated and saved so that the annotations are text searchable using the graphical user interface.

In addition, the user has the option of searching annotations using a “partial search” for any of the annotated voice tags stored in the database, enabling the user to instantly retrieve a deposition that was recorded previously. The user has the option to download the audio, download a playlist of the audio files, or email a playlist to others.

The user may also use the graphical user interface to request approval for the cost of creating a transcript, and then once receiving approval the user may then order the transcript using the graphical user interface. When a transcription company has completed the transcript, the user may be notified via email that it is complete and available to download using the graphical user interface.

In addition, attorneys belonging to the deposing attorney's organization, or from another organization that have permission to view the deposing attorney organization's depositions, may search, access, and perform all the same functions as the deposing attorney.

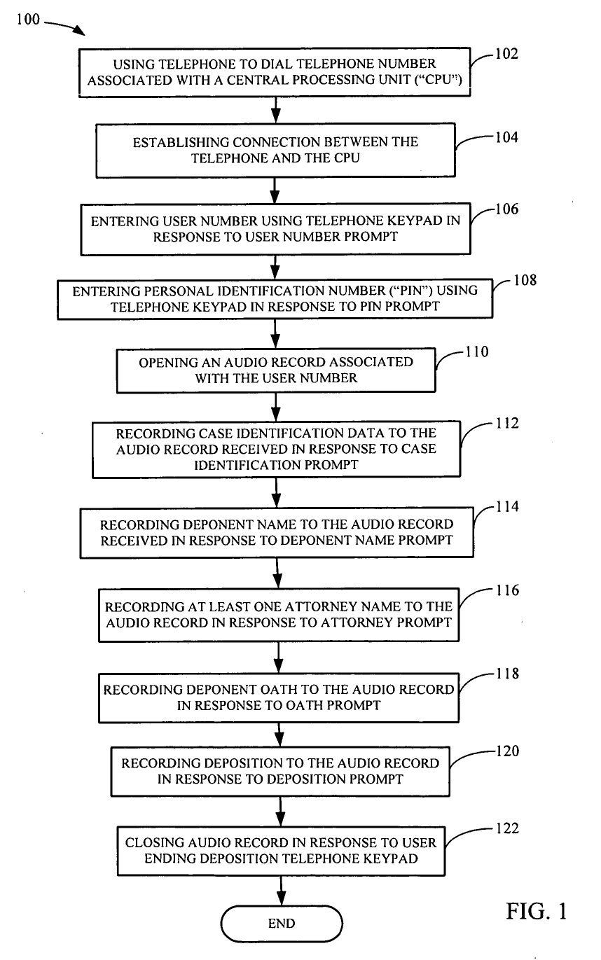

Referring now to FIG. 1, a particular illustrative embodiment of a method and system for automated telephonic deposition recording and transcription is disclosed and generally designated 100. A keypad of a remote telephone is used to dial a telephone number associated with the CPU, at 102. Continuing to 104, a connection is established between the remote telephone and the CPU. A user number is entered using a remote telephone keypad in response to a user number prompt, at 106, and a personal identification number (“PIN”) is entered at 108. An audio record is then opened, at 110, wherein the audio record is associated with the user number. Case identification data is recorded to the audio record in response to a case identification prompt, at 112. Moving to 114, a deponent name is recorded to the audio record in response to a deponent name prompt. At least one attorney name is recorded to the audio file, at 116, in response to an attorney prompt. A deponent oath is recorded to the audio record in response to an oath prompt, at 118. A deposition is then recorded, at 120, in response to a deposition prompt. The audio record is closed in response to the user ending recording the deposition by using the remote telephone keypad, at 122.

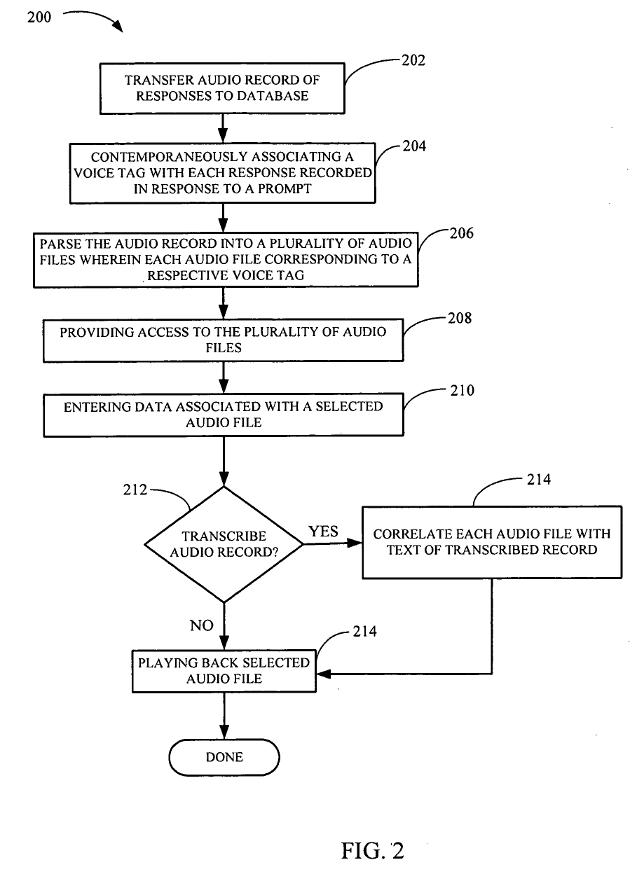

A particular illustrative embodiment of a method for accessing audio records of a deposition is illustrated in FIG. 2 and generally designated 200. At 202, an audio record is transferred to a database. A voice tag is contemporaneously associated with each response recorded in response to a prompt, at 204. The audio record is parsed into a plurality of audio files, at 206, wherein each audio file corresponds to a respective voice tag. Continuing to 208, access is provided to the plurality of audio files. At 210, data may be entered and associated with a selected audio file. If the audio record is selected to be transcribed, at 212, then each audio file is correlated with text of a transcribed record. The selected audio file may then be played back, at 214.

A diagram of a particular illustrative embodiment of a system for automated telephonic deposition recording and transcription is disclosed in FIG. 3 and generally designated as 300. For example, a deposing attorney 312, opposing attorney 314 and deponent 318 are physically present at a first location. The first location includes a conference telephone 316 in electrical communication with a CPU 320. The conference telephone 316 is used to transmit an audio recording of the deposition to the CPU 320. A keypad of the conference telephone 316 is also used to dial a telephone number associated with the CPU to establish a connection in accordance with the method of FIG. 1. The keypad is used to respond to various audio prompts originating from the CPU 320.

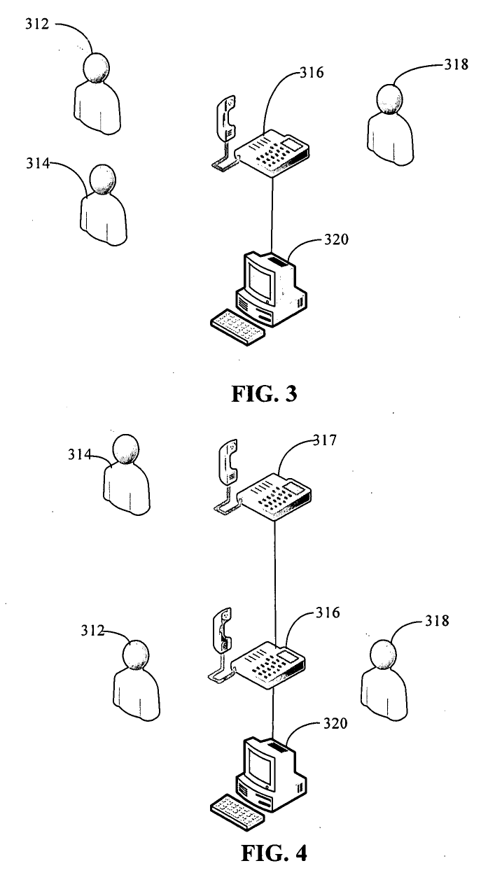

Referring now to FIG. 4, a particular illustrative embodiment of a system for automated telephonic deposition recording and transcription with a third party at a remote location is disclosed. In this example, the opposing attorney 314 is at a remote location including a remote telephone 317. The opposing attorney 314 uses the remote telephone 317 to establish a connection to the conference telephone 316 and/or CPU 320. The deposing attorney 312 and deponent 318 are at the local location and the conference telephone 316 is used to establish a connection to the CPU 320.

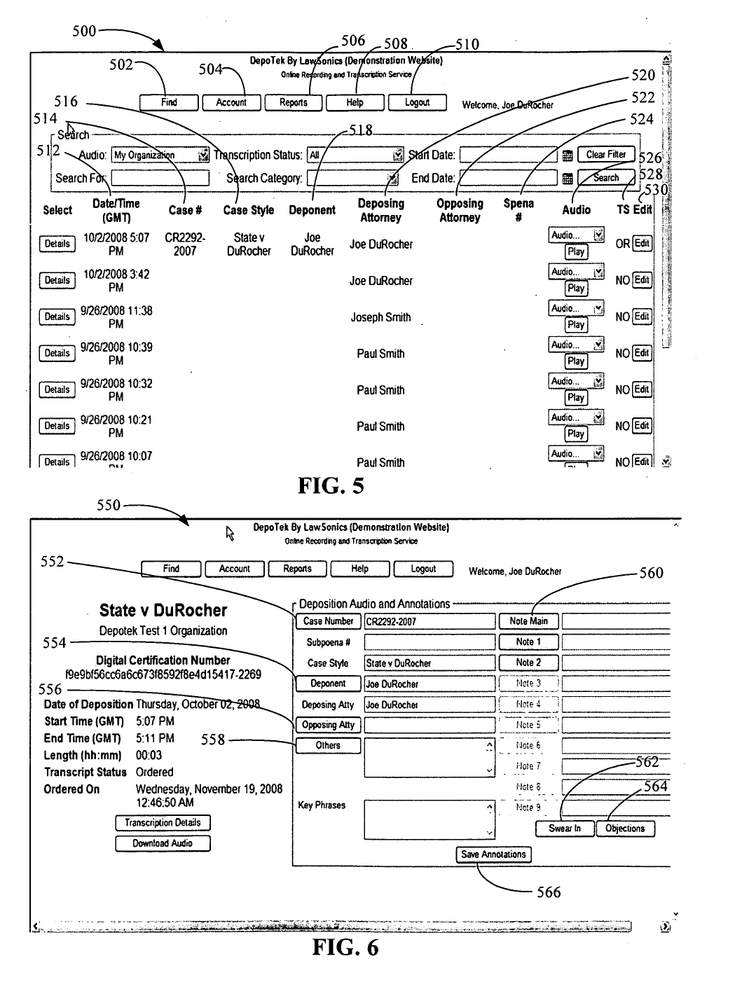

A graphical user interface (“GUI”) 500 shown in FIG. 5 may be used by a user to search for audio records of a selected deposition created in accordance with the method of FIGS. 1 and 2. The GUI 500 provides access to a user by selecting icons designated as “Find” 502, “Account” 504, “Reports” 506, “Help” 508, and “Logout” 510. For example, information regarding data stored in a database includes “Date/Time” 512, “Case Number” 514, “Case Style” 516, “Deponent” 518, “Deposing Attorney” 520, “Opposing Attorney” 522, “Subpoena No.” 524, “Audio” 526, “Transcription Status” 528 and “Edit” 530.

The GUI 550 shown in FIG. 6 displays a number of icons that may be selected by the user. For example, the user may select to playback voice tags identified with “Case Number” 552, “Deponent” 554, “Opposing Attorney” 556, or “Other Attendees” 558, for a particular deposition. In addition, the user may use GUI 550 to annotate the voice tags by entering text into field boxes displayed adjacent to the icons 552, 554, 556, 558, 560, while listening to the respective voice tags. The field boxes containing the text are searchable in the database.

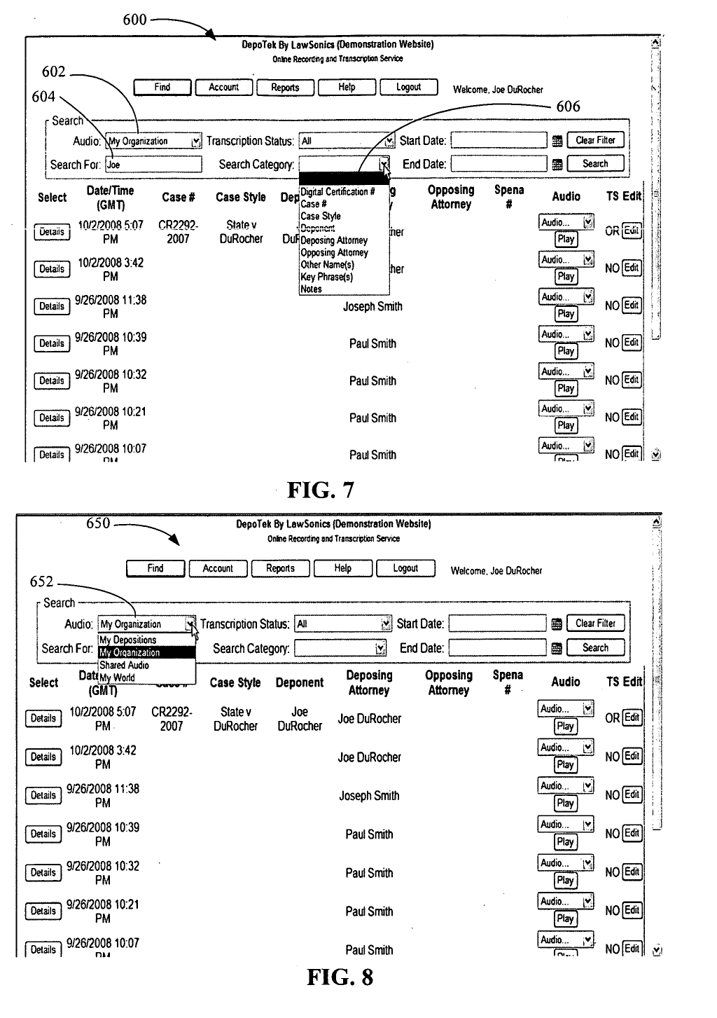

Referring now to FIG. 7, the user may search depositions stored in the database by using GUI 600. For example, the user selects to search for all depositions associated with “My Organization” 602. The user refines the search process by entering to search depositions that also contain “Joe” 604. In addition, the search process can be even further refined by using a drop down menu 606, that allows to select to search for “Joe” as the “Deponent”, “Deposing Attorney”, “Opposing Attorney”, etc. Further, the user may search for depositions associated with only a particular attorney as illustrated in FIG. 8, by selecting “My Depositions” from a drop down menu 652, or “My Organization” (as explained above), “Shared Audio”, and “My World.” The “Shared Audio” selection will return deposition search results from a different organization that has elected to share its depositions. The “My World” selection will return deposition search results from either the user's organization or any organization that has elected to share its depositions.

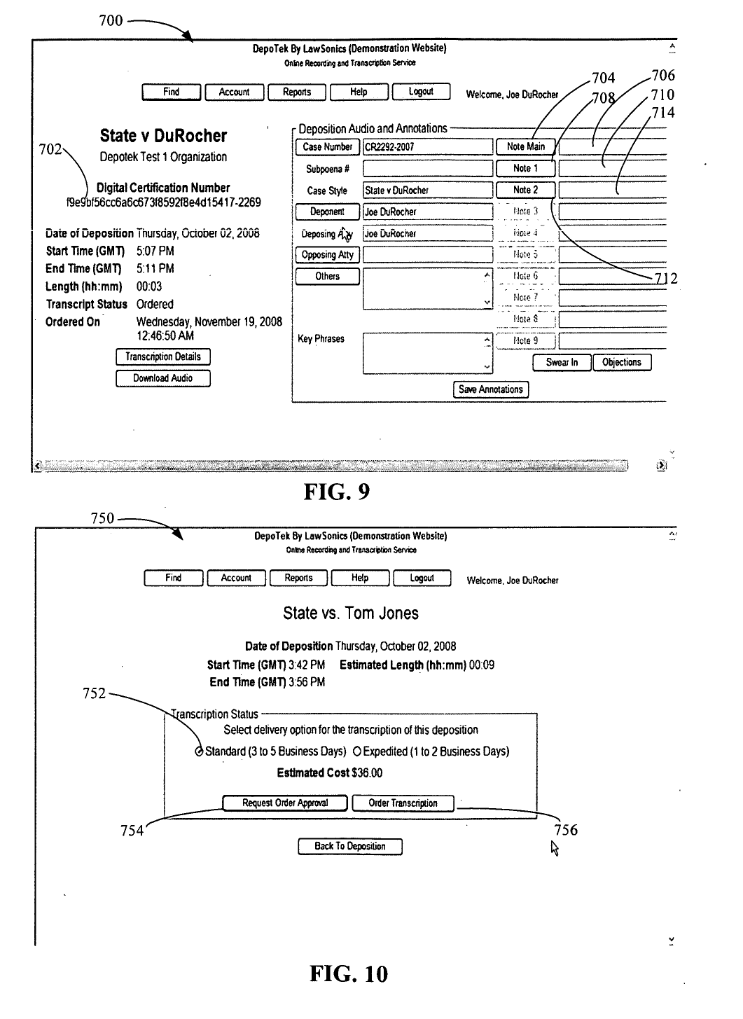

The user may playback and annotate audio segments of the depositions using GUI 700 of FIG. 9. For this particular deposition of “Joe DuRocher” there are three notes 704, 708, 712. During the deposition, the attorney pressed the number one key on the telephone keypad to create “Note 1” and then later pressed the two key on the telephone keypad to create “Note 2,” displayed by the GUI 700, in addition to “Note Main” 704. Next to icons 704, 708, 712 for “Note Main,” “Note 1,” and “Note 2,” respectively, are field boxes 706, 710, 712 to allow the attorney to create text searchable phrases next to each of the deposition audio segments.

A transcript of a deposition may be ordered using GUI 750 shown in FIG. 10. The user may obtain an instant transcription quote by selecting the “Standard (3 to 5 Business Days)” icon 752, or selecting the “Expedited (1 to 2 Business Days)” icon. Once the user has selected the delivery option for the transcript, the user may select the “Request Order Approval” button 754 that instructs the system to issue an email with all pertinent transcript information to an administrator for approval. If approval for a transcript is received, then an “Order Transcription” button 756 may be selected and the stored deposition information and audio from the database is automatically sent to a transcription service. When the transcript is completed, an email notifies the user that the transcript is available for download using the graphical user interface.

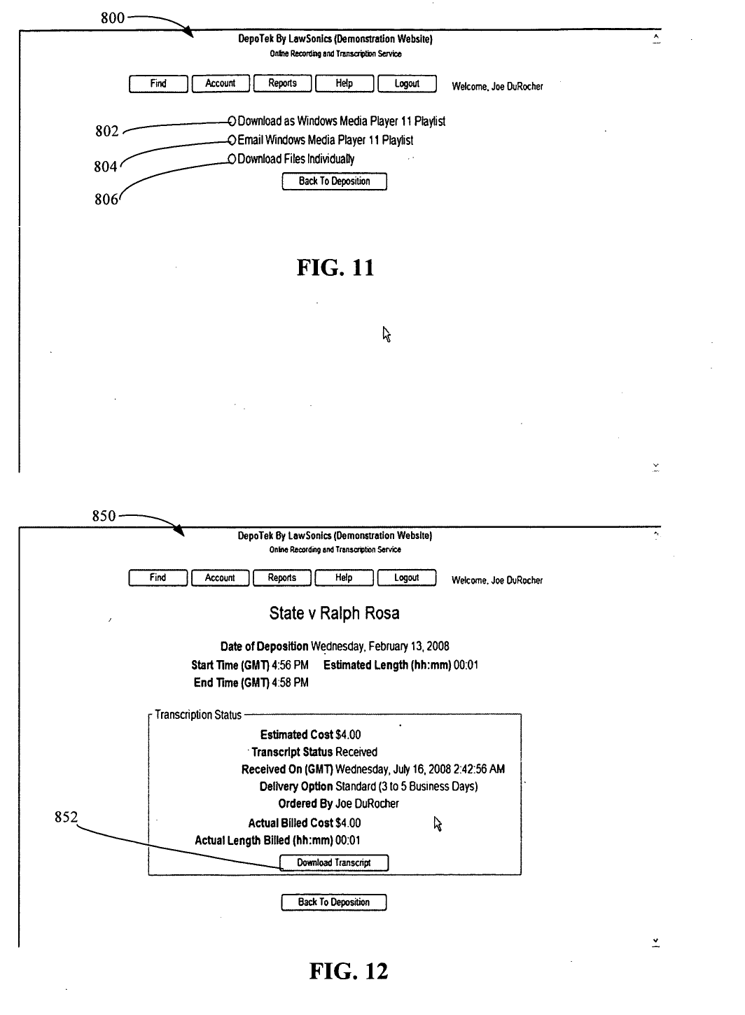

Referring now to FIG. 11, a GUI 800 may be used to select downloading audio of a deposition or sending the audio to another person. A first option presented is “Download a Windows Media Player Playlist” 802, which enables the user to play all the voice tags and deposition main audio and notes as one contiguous file. A second option presented is to email the same playlist to another person by selecting “Email Windows Media Player Playlist” 804, which allows the recipient of the email to play all the voice tags and deposition main audio and notes as one contiguous file. A third option presented is “Download Files Individually” 806, which allows the user to download any of the deposition voice tags or audio segments of the deposition directly to the user's local computer. This enables the user to transport the deposition audio with them if traveling or to burn a CD or transport the deposition to a portable media player device, for example.

As part of the GUI 850, a confirmation page is displayed indicating that a particular transcript has been ordered. Relevant data of a transcription status is displayed along with a “Download Transcript” 852 option, which allows a deposition to be downloaded in accordance with FIG. 11 described above.

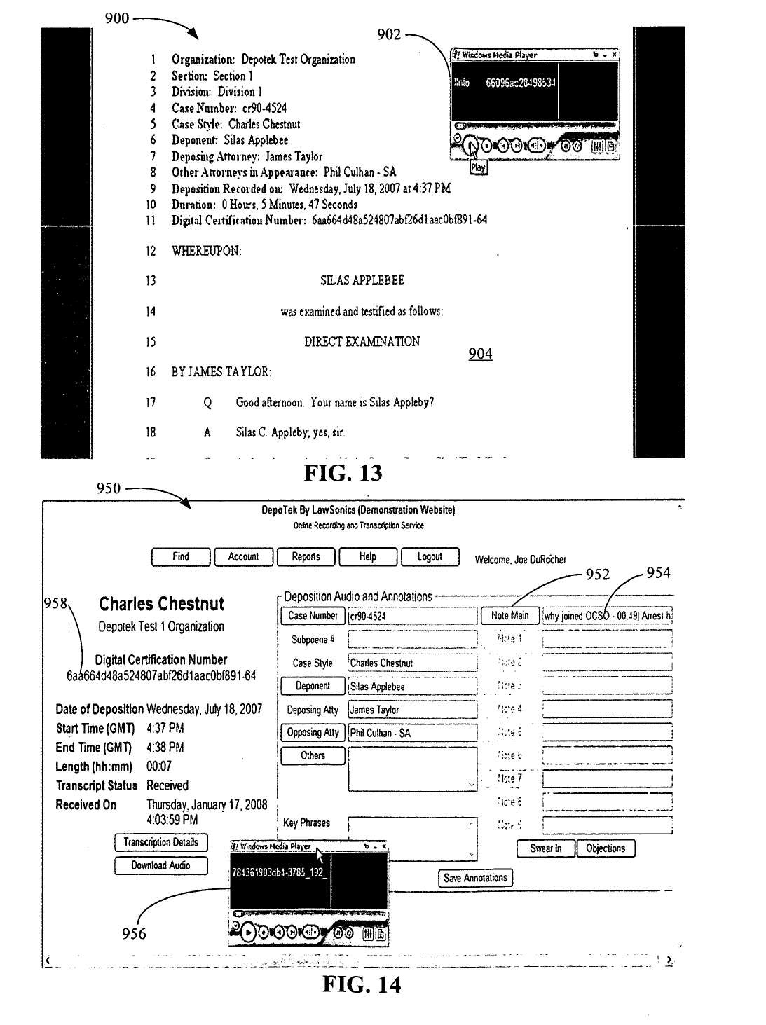

A portion of a deposition transcript is displayed in FIG. 13 within GUI 900. A media player 902 may be used to playback audio segments from the deposition contemporaneously with displaying the respective textual portion of the transcript.

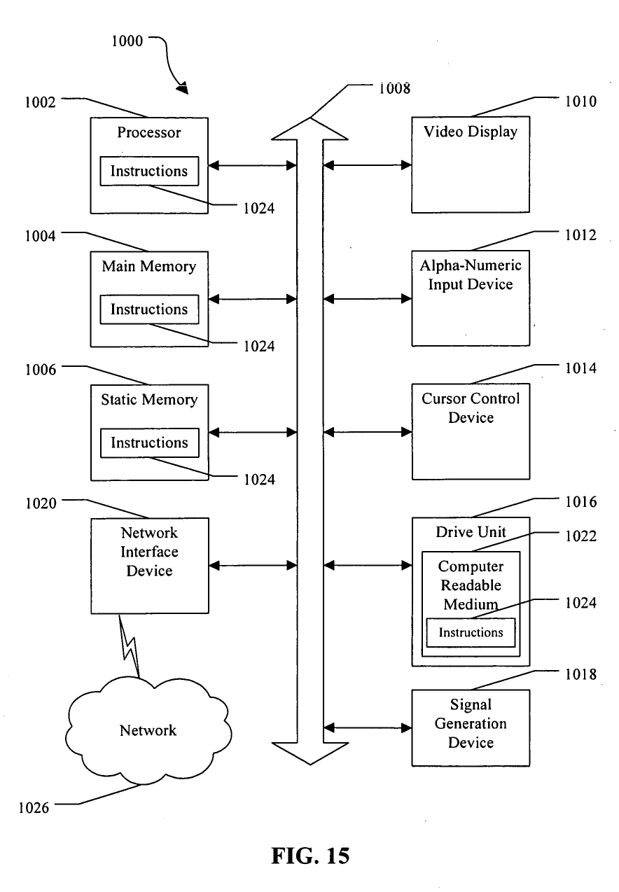

Referring now to FIG. 14, a user selected “Note Main” 952 as the media player 956 to play back an audio segment of a deposition of “Silas Applebee,” in this example. A Digital Certification Number 958 is displayed in the GUI 950 for each deposition. The Digital Certification Number 958 is used to track a deposition from the moment the attorney initiate a deposition using the voice phone center to when the audio files are transferred to the database, to when the user accesses the deposition using the GUI, to when the transcript is ordered and downloaded.

As illustrated in FIG. 15, the computer system 1000 of the voice phone center may include a processor 1002, e.g., a central processing unit (CPU), a graphics-processing unit (GPU), or both. Moreover, the computer system 1000 can include a main memory 1004 and a static memory 1006 that can communicate with each other via a bus 1008. As shown, the computer system 1000 may further include a video display unit 1010, such as a liquid crystal display (LCD), a flat panel display, a solid-state display, or a cathode ray tube (CRT). Additionally, the computer system 1000 may include an input device 1012, such as a keyboard, and a cursor control device 1014, such as a mouse. The computer system 1000 can also include a disk drive unit 1016, a signal generation device 1018, such as a speaker or remote control, and a network interface device 1020 that may be in communication with a network 1026 and telephony system.

In a particular embodiment, as depicted in FIG. 15, the disk drive unit 1016 may include a computer-readable medium 1022 in which one or more sets of instructions 1024, e.g. software, can be embedded. Further, the instructions 1024 may embody one or more of the methods or logic as described herein. In a particular embodiment, the instructions 1024 may reside completely, or at least partially, within the main memory 1004, the static memory 1006, and/or within the processor 1002 during execution by the computer system 1000. The main memory 1004 and the processor 1002 also may include computer-readable media. For example, the instructions 1024 may include instructions to cause a processor to transfer the audio record to a database, contemporaneously associate a voice tag with each response recorded in response to a prompt, parse the audio record into a plurality of audio files, wherein each audio file corresponds to a respective voice tag, provide access to the plurality of audio files, enter text associated with a selected audio file, correlate each audio file with text of the audio record when the audio record has been transcribed, and play back a selected audio file.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope possible consistent with the principles and novel features as defined herein.

What is claimed is:

1. A method comprising:
dialing a telephone number associated with a central processing unit (“CPU”);
establishing a connection between a conference telephone and the CPU;
entering a user number using a telephone keypad in response to a user number prompt;
entering a personal identification number (“PIN”) using the telephone keypad in response to a PIN prompt;
opening an audio record associated with the user number;
recording at least one response to at least one audio prompt issued by the CPU;
recording a deposition to the audio record in response to a deposition prompt; and
closing the audio record using the telephone keypad.

2. The method of claim 1, further comprising establishing a connection between at least one remote telephone and the conference telephone.

3. The method of claim 1, further comprising recording case identification data to the audio record in response to case identification prompt.

4. The method of claim 3, further comprising recording deponent name to the audio record in response to deponent name prompt.

5. The method of claim 4, further comprising recording at least one attorney name to the audio record in response to attorney prompt.

6. The method of claim 5, further comprising recording a deponent oath to the record in response to oath prompt.

7. The method of claim 1, further comprising:
transferring the audio record to a database;
contemporaneously associating a voice tag with each response recorded in response to a prompt;
parsing the audio record into a plurality of audio files, wherein each audio file corresponds to a respective voice tag;
providing access to the plurality of audio files;
entering text associated with a selected audio file;
correlating each audio file with text of the audio record when the audio record has been transcribed; and
selecting an audio file to play back using a graphical user interface (“GUI”).

8. The method of claim 7, further comprising searching the plurality of audio records in accordance with user selected search criteria.

9. The method of claim 8, wherein the GUI controls displaying and reviewing user selected portions of the audio record.

10. The method of claim 9, wherein the GUI further comprises at least one drop down menu to select the search criteria.

11. A system for automated telephonic deposition recording and transcription, the system comprising:
a conference telephone to dial a telephone number associated with a central processing unit (“CPU”);
a connection between the conference telephone and CPU;
a telephone keypad to enter a response to a prompt issued by the CPU;
an audio record to record a deposition; and
a storage device to store the audio record.

12. The system of claim 11, further comprising a second connection between a remote telephone and the conference telephone.

13. The system of claim 11, further comprising computer readable storage medium containing executable instructions, which, when executed by a processor, cause the processor to:
transfer the audio record to a database;
contemporaneously associate a voice tag with each response recorded in response to a prompt;
parse the audio record into a plurality of audio files, wherein each audio file corresponds to a respective voice tag;
provide access to the plurality of audio files;
enter text associated with a selected audio file;
correlate each audio file with text of the audio record when the audio record has been transcribed; and
play back a selected audio file.

14. The system of claim 13, further comprising a graphical user interface (“GUI”) to search the plurality of audio records in accordance with user selected search criteria.

15. The system of claim 14, wherein the GUI controls displaying and reviewing user selected portions of the audio record.

16. The system of claim 15, wherein the GUI further comprising at least one drop down menu to select the search criteria.

17. The system of claim 16, further comprising a note function to separate the audio record into a plurality of segments.

18. The system of claim 17, further comprising means to convert the audio record to a transcript comprised of text.

19. The system of claim 18, wherein the GUI is in communication with an Internet.

20. The system of claim 19, further comprising a digital certification number assigned to the audio record.
